(19) United States
(12) Patent Application Publication
(10) Pub. No.: US 2007/0290965 A1
(43) Pub. Date: Dec. 20, 2007

(54) LIQUID CRYSTAL DISPLAY DEVICE

(76) Inventor: Naoya Shiraishi, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/762,813

(22) Filed: Jun. 14, 2007

(30) Foreign Application Priority Data
Jun. 19, 2006 (JP) 2006-168743

(51) Int. Cl. G09G 3/36

(52) U.S. Cl. 345/87; 345/600; 345/605

(57) ABSTRACT

The invention provides a miniaturized liquid crystal display device used in a mobile phone or the like which prevents the possibility of short-circuiting of lines of a flexible printed circuit board which supplies a power source or the like to a liquid crystal display device due to a phenomenon that a punch-out hole formed in the flexible printed circuit board at a plating terminal is brought into contact with a frame made of metal. Pins are formed on a holder on which a liquid crystal panel is mounted, and the pins of the holder are inserted into the punch-out hole formed in the flexible printed circuit board at the plating terminal and a pin hole formed in the frame. Lines made of metal are exposed on an inner side of the punch-out hole formed in the flexible printed circuit board at a plating terminal. Although there may exist the possibility that the lines are brought into contact with the pin of the holder, the holder is made of a resin and constitutes an insulator and hence, short-circuiting can be prevented. Further, a hole is formed in the frame, and the pins of the holder functions as a stopper and hence, there is no possibility that the punch-out hole formed in the flexible printed circuit board at the plating terminal is brought into contact with the frame made of metal. Accordingly, it is possible to prevent short-circuiting of lines of the flexible printed circuit board attributed to a phenomenon that the metal frame is brought into contact with the punch-out hole formed in the flexible printed circuit board at the plating terminal.

### CROSS-REFERENCE TO RELATED APPLICATIONS

The disclosure of Japanese Patent Application No. 2006-168743 filed on Jun. 19, 2006 including the specification, drawings and abstract is incorporated herein by reference in its entirety.

### BACKGROUND OF THE INVENTION

1. Field of the Invention

The present invention relates to a miniaturized liquid crystal display device used in a mobile phone or the like, and more particularly to a technique which enables the acquisition of a display device which can reduce a profile size of a set and can possess high reliability.

2. Description of the Related Art

In a liquid crystal display device, there has been a strong demand for the reduction of a profile size of a set while maintaining a screen at a fixed size. To satisfy this demand, various attempts have been made including the narrowing of a picture frame of a display screen, the enhancement of parts accuracy and the reduction of thickness of a holder which houses liquid crystal, the enhancement of parts accuracy and the reduction of thickness of a metal frame which forms an outer frame, the miniaturization of the backlight structure and the like. Further, in another attempt, a power source circuit which drives a liquid crystal display device, a circuit which drives a backlight, light emitting diodes (LED) which constitutes a light source and the like are collectively mounted on a flexible printed circuit board, and the flexible printed circuit board is mounted on a liquid crystal panel thus realizing the simultaneous mounting of these parts on the display device.

FIG. 15 is a plan view showing a state in which a flexible printed circuit board is mounted on a liquid crystal display device for a mobile phone. In FIG. 15, out of a liquid crystal panel 1 which displays an image, an upper glass substrate 2, a lower glass substrate 3 and an upper polarizer 4 are shown in a plan view. Scanning lines, signal lines and the like are formed on the lower glass substrate 3 and, at the same time, TFTs for switching liquid crystal are also formed on the lower glass substrate 3. The lower glass substrate 3 has a length larger than a length of the upper glass substrate 2 in the longitudinal direction. IC chips 6 for driving the liquid crystal are mounted on the lower glass substrate 3. A power source, signals and the like for driving the IC chips 6 are supplied from the flexible printed circuit board 7. The flexible printed circuit board 7 is connected with the lower glass substrate 3. The liquid crystal panel 1 is mounted on a holder 5 which is made of a resin.

The flexible printed circuit board 7 has a large area as shown in FIG. 15 and hence, the flexible printed circuit board 7 is used in a state that the flexible printed circuit board 7 is folded back on a back side of the liquid crystal panel 1. The liquid crystal panel 1 and the flexible printed circuit board 7 in such a state are shown in FIG. 16 which is a plan view and FIG. 17 which is a side partial cross-sectional view. As shown in FIG. 16 and FIG. 17, the flexible printed circuit board 7 is connected to an end portion of the lower glass substrate 3, surrounds an end portion of the holder 5, and is folded back to the back side of the liquid crystal panel 1 or a back side of the holder 5. In FIG. 17, the positioning of the flexible printed circuit board 7 and the holder 5 can be performed by inserting a holder pins 51 formed on the holder 5 into positioning holes 74 formed in the flexible printed circuit board 7.

Thereafter, an assembled body of the liquid crystal panel 1, the holder 5, the flexible printed circuit board 7 and the like is, as shown in FIG. 18, housed in a metal frame 8 thus completing a display device.

As literatures which describe the above-mentioned related art, for example, Japanese Patent Laid-open 2001-133756 (patent document 1), Japanese Patent Laid-open 2004-29651 (patent document 2), Japanese Patent Laid-open 2004-62048 (patent document 3) and Japanese Patent Laid-open 2005-338497 (patent document 4) are named.

### SUMMARY OF THE INVENTION

The flexible printed circuit board 7 is an essential part on which parts such as a power source circuit for driving the liquid crystal panel 1, an LED 17 which constitutes a light source of the backlight, a backlight drive circuit and the like are mounted. Before such parts are mounted on the flexible printed circuit board 7, the flexible printed circuit board 7 is formed such that a copper foil is applied to a base film made of polyimide by coating, and lines 73 are formed by etching or the like. Copper plating is further applied to the lines 73 made of copper. To perform copper plating, it is necessary to supply an electric potential to all lines 73. Here, the formation of an electrode on each is inefficient and hence, the lines are collected at one place thus forming a plating terminal 71, and an electric potential for plating is supplied to all lines from the plating terminal 71. This state is shown in FIG. 19.

On the flexible printed circuit board 7, the lines 73 are formed longitudinally as well as laterally. In an example shown in FIG. 19, although four lines are connected to the plating terminal 71, these four lines are connected with all lines 73 on the flexible printed circuit board 7. It is needless to say that the four-line arrangement constitutes one example and, in many cases, five or more lines may be connected with the plating terminal 71. Accordingly, in applying plating to the lines 73, it is possible to apply plating to all lines 73 by merely supplying an electric current to the plating terminal 71. Here, the positioning holes 74 which are aligned with the holder pins 51 are formed on both sides of the flexible printed circuit board 7.

Then, a cover film made of polyimide is formed on the copper lines 73 by way of an epoxy-based adhesive material thus protecting the copper lines 73. Thereafter, by punching out the plating terminal 71 using a press or the like, the necessary insulation between the lines is ensured. This state is shown in FIG. 20. FIG. 20 shows a state in which the plating terminal 71 is punched out and a punch-out hole 72 remains.

A cross-sectional shape of the vicinity of the punch-out hole 72 formed in the flexible printed circuit board 7 explained heretofore is shown in FIG. 20. A base film 721 is made of polyimide and has a thickness of 25 μm, for example.

A copper foil 722 which forms the lines 73 is mounted on the base film 721, and electrolytic copper plating 723 is formed on the copper foil. A thickness of the copper foil 722 is 12 μm and a thickness of the copper plating 723 is 8 μm. On the copper plating 723, an epoxy-based adhesive material 724 having a thickness of 18 μm is formed as a film by coating, and a cover film 725 made of polyimide and having a thickness of 12 μm covers and protects the lines 73 by way of the adhesive material 724. Here arises a drawback that the copper foil 722 which forms the copper lines 73 and the copper plating 723 are exposed. That is, when a conductive object is brought into contact with such portions, the lines in the inside of the flexible printed circuit board 7 are short-circuited thus giving rise to an erroneous operation.

Further, when the punch-out hole 72 is formed by a press or the like, depending on the punch-out direction, sagging is formed as shown in FIG. 22 and hence, when a conductive material such as metal exists in the vicinity of the punch-out hole 72, possibility of line short-circuiting in the vicinity of the punch-out hole 72 is further increased. Although FIG. 22 shows the case in which the punch-out hole 72 is punched out in the vertical direction, it is needless to say that the same drawback arises when the punch-out hole 72 is also punched out in the downward direction.

This short-circuiting problem in the vicinity of the punch-out hole 72 at the plating terminal 71 arises, to be more specific, when the liquid crystal panel 1, the flexible printed circuit board 7 and the holder 5 are assembled into the frame 8. This is because that the frame 8 is made of metal such as stainless steel, aluminum or aluminum alloy or the like. A state of such a portion is shown in FIG. 23. In FIG. 23, the flexible printed circuit board 7 extends below the holder 5 and is brought into contact with a bottom of the frame 8 made of metal. Accordingly, in the related art, the punch-out hole 72 at the plating terminal 71 of the flexible printed circuit board 7 is brought into contact with the metal frame 8 thus giving rise to a possibility of line short-circuiting of the flexible printed circuit board 7.

The invention has been made to overcome the above-mentioned drawbacks, and it is an object of the invention to provide a highly reliable display device which suppresses a possibility of short-circuiting of a flexible printed circuit board. The display device is substantially constituted as follows.

(1) A liquid crystal display device includes: a liquid crystal panel; a holder which mounts the liquid crystal panel on an upper surface thereof; a flexible printed circuit board which is connected with the liquid crystal panel; and a frame which houses the holder.

In the above-mentioned constitution, the flexible printed circuit board is configured such that the flexible printed circuit board extends on a back surface of the holder while surrounding a side surface of the holder, plating is applied to a line portion of the flexible printed circuit board, the plating is applied to the flexible printed circuit board using a plating terminal for applying plating and, thereafter, a hole for removing the plating terminal is formed in the flexible printed circuit board thus ensuring necessary insulation between lines. A holder pin is formed on the holder. A pin hole is formed in the frame. The holder pin is inserted into the hole for removing the plating terminal of the flexible printed circuit board and the pin hole formed in the frame. The pin hole formed in the frame is larger than the hole for removing the plating terminal of the flexible printed circuit board.

(2) In a liquid crystal display device which includes: a liquid crystal panel; a backlight which includes a light guide plate arranged on a back surface of the liquid crystal panel; a reflection sheet arranged on a back surface of the light guide plate; a holder which mounts the liquid crystal panel, the backlight and the reflection sheet therein; a flexible printed circuit board which is connected with the liquid crystal panel; and a frame which houses a holder therein, the liquid crystal display device further has the following constitution.

The flexible printed circuit board is configured such that the flexible printed circuit board extends on a back surface of the reflection sheet while surrounding a side surface of the holder, plating is applied to a line portion of the flexible printed circuit board, the plating is applied to the flexible printed circuit board using a plating terminal for applying plating and, thereafter, a hole for removing the plating terminal is formed in the flexible printed circuit board to ensure necessary insulation between lines. The hole for removing the plating terminal of the flexible printed circuit board is provided between the reflection sheet and the frame. Insulation treatment is applied to a side of the reflection sheet in which the hole for removing the plating terminal is formed. An insulation paint is applied to a portion of the frame corresponding to the hole for removing the plating terminal.

(3) In a liquid crystal display device which includes: a liquid crystal panel; a backlight which includes a light guide plate arranged on a back surface of the liquid crystal panel; a reflection sheet arranged on a back surface of the light guide plate; a holder which mounts the liquid crystal panel, the backlight and the reflection sheet therein; a flexible printed circuit board which is connected with the liquid crystal panel; and a frame which houses a holder therein, the liquid crystal display device further has the following constitution.

The flexible printed circuit board is configured such that the flexible printed circuit board extends on a back surface of the reflection sheet while surrounding a side surface of the holder, plating is applied to a line portion of the flexible printed circuit board, the plating is applied to the flexible printed circuit board using a plating terminal for applying plating and, thereafter, a hole for removing the plating terminal is formed in the flexible printed circuit board to ensure necessary insulation between lines. The hole for removing the plating terminal of the flexible printed circuit board is provided between the reflection sheet and the frame. Insulation treatment is applied to a side of the reflection sheet in which the hole for removing the plating terminal is formed. An insulation film is formed on an inner side of the frame.

(4) In a liquid crystal display device which includes: a liquid crystal panel; a backlight which includes a light guide plate arranged on a back surface of the liquid crystal panel; a reflection sheet arranged on a back surface of the light guide plate; a holder which mounts the liquid crystal panel, the backlight and the reflection sheet therein; a flexible printed circuit board which is connected with the liquid crystal panel; and a frame which houses a holder therein, the liquid crystal display device further has the following constitution.

The flexible printed circuit board is configured such that the flexible printed circuit board extends on a back surface of the reflection sheet while surrounding a side surface of the holder, plating is applied to a line portion of the flexible printed circuit board, the plating is applied to the flexible printed circuit board using a plating terminal for applying plating and, thereafter, a hole for removing the plating terminal is formed in the flexible printed circuit board to ensure necessary insulation between lines. The hole for removing the plating terminal formed in the flexible printed circuit board is provided at a portion of the flexible printed circuit board which corresponds to a back surface of the reflection sheet. Insulation treatment is applied to a side of the reflection sheet in which the hole for removing the plating terminal is formed. A hole is formed in a portion of the frame which corresponds to the hole for removing the plating terminal formed in the flexible printed circuit board. The hole formed in the frame is larger than the hole for removing the plating terminal formed in the flexible printed circuit board and has a diameter of 6.1 mm or less.

The respective inventions having the above-mentioned constitutions can obtain following advantageous effects.

According to the invention having the constitution (1), the holder pin formed on the holder is inserted into the punch-out hole formed in the flexible printed circuit board at the plating terminal. Accordingly, even when the punch-out hole is displaced, the pin functions as a stopper thus preventing the punch-out hole from being largely displaced. Further, even when the punch-out hole formed in the flexible printed circuit board at the plating terminal is displaced, by designing the punch-out hole within a range of the frame pin hole 81 formed in the frame, there is no possibility that the punch-out hole is brought into contact with the metal frame and hence, it is possible to prevent the possibility of short-circuiting attributed to a phenomenon that a line of the flexible printed circuit board is brought into contact with the frame made of metal via the punch-out hole. Further, for assembling the holder and the flexible printed circuit board and for assembling the holder and the frame, conventionally, a holder pin is formed on a holder, and the holder pin, a hole formed in a flexible printed circuit board or holes formed in the holder pin and the frame have been used for guiding such assembling. According to the invention, without changing such a process or without increasing an additional process, it is possible to obtain remarkably advantageous effect that short-circuiting of lines attributed to the punch-out hole formed in the flexible printed circuit board at the plating terminal can be prevented.

According to the invention having the constitution (2), without making any change of a shape of the flexible printed circuit board, the plating terminal, the punch-out hole at the plating terminal or the like, by merely applying the insulation paint to the inner side of the frame by coating, it is possible to prevent short-circuiting of lines attributed to the punch-out hole formed in the flexible printed circuit board at the plating terminal. Further, the large tolerance or the like can be ensured in a painting range of such paint and hence, it is possible to minimize the increase in cost attributed to the increase of the operation. Still further, according to the invention having the constitution (2), the punch-out hole formed in the flexible printed circuit board at the plating terminal is not exposed to an external environment and hence, it is possible to prevent short-circuiting of lines extending from the punch-out hole formed in the flexible printed circuit board at the plating terminal attributed to the adhesion of a conductive material or the like from the outside.

According to the invention having the constitution (3), without making any change of a shape of the flexible printed circuit board, the plating terminal, the punch-out hole at the plating terminal or the like, at least the insulation film is formed on the inner side of the frame and hence, it is possible to prevent short-circuiting of lines attributed to the punch-out hole formed in the flexible printed circuit board at the plating terminal. Further, according to the invention having the constitution (3), the punch-out hole formed in the flexible printed circuit board at the plating terminal is not exposed to external environments and hence, it is possible to prevent short-circuiting of lines extending from the punch-out hole formed in the flexible printed circuit board at the plating terminal attributed to the adhesion of a conductive material or the like from the outside.

According to the invention having the constitution (4), without making any change of a shape of the flexible printed circuit board, the plating terminal, the punch-out hole at the plating terminal or the like, by properly designing at least the escape hole formed in the frame which avoids the punch-out hole at the plating terminal, it is possible to prevent short-circuiting of lines attributed to the punch-out hole formed in the flexible printed circuit board at the plating terminal thus enhancing the reliability of the liquid crystal display device and, at the same time, suppressing the increase of a manufacturing cost attributed to the short-circuiting of the lines.

### BRIEF DESCRIPTION OF THE DRAWINGS

FIG. 1 is a plan view of a liquid crystal display device of an embodiment 1 of the invention;

FIG. 2 is a cross-sectional view of the liquid crystal display device of the embodiment 1 of the invention;

FIG. 3 is a view showing the liquid crystal display device of the embodiment 1 of the invention in detail;

FIG. 4 is a back view of the liquid crystal display device of the embodiment 1 of the invention;

FIG. 5 is a plan view of a flexible printed circuit board which is used in the invention in an intermediate step;

FIG. 6 is a plan view of the flexible printed circuit board which is used in the invention;

FIG. 7 is a cross-sectional view of a liquid crystal display device of an embodiment 2 of the invention;

FIG. 8 is a side view of the liquid crystal display device of the embodiment 2 of the invention;

FIG. 9 is a plan view of a liquid crystal display device of an embodiment 3 of the invention;

FIG. 10 a cross-sectional view of the liquid crystal display device of the embodiment 3 of the invention;

FIG. 11 is a cross-sectional view showing the liquid crystal display device of the embodiment 3 of the invention in detail;

FIG. 12 is a cross-sectional view of a liquid crystal display device of an embodiment 4 of the invention;

FIG. 13 is a cross-sectional view of a liquid crystal display device of an embodiment 5 of the invention;

FIG. 14 is a back view of the liquid crystal display device of the embodiment 5 of the invention;

FIG. 15 is a plan view of a flexible printed circuit board of a related art showing a state before the flexible printed circuit board is bent in an intermediate step of a product;

FIG. 16 is a plan view of the flexible printed circuit board of the related art showing a state after the flexible printed circuit board is bent in the intermediate step of the product;

FIG. 17 is a cross-sectional view of a part shown in FIG. 16;

FIG. 18 is a cross-sectional view of a part of the product of the related art;

FIG. 19 is a plan view of the flexible printed circuit board in the intermediate step;

FIG. 20 is a plan view of the flexible printed circuit board;

FIG. 21 is a cross-sectional view of a punch-out hole portion formed in the flexible printed circuit board at a plating terminal;

FIG. 22 is a cross-sectional view showing a case in which sagging of the punch-out hole is generated in the flexible printed circuit board at the plating terminal when the punch-out hole is formed by a press; and

FIG. 23 is a cross-sectional view showing the relationship between the punch-out hole formed in the flexible printed circuit board at the plating terminal and a metal frame in a related art.

### DESCRIPTION OF THE PREFERRED EMBODIMENTS

The invention is explained in detail in conjunction with embodiments.

### Embodiment 1

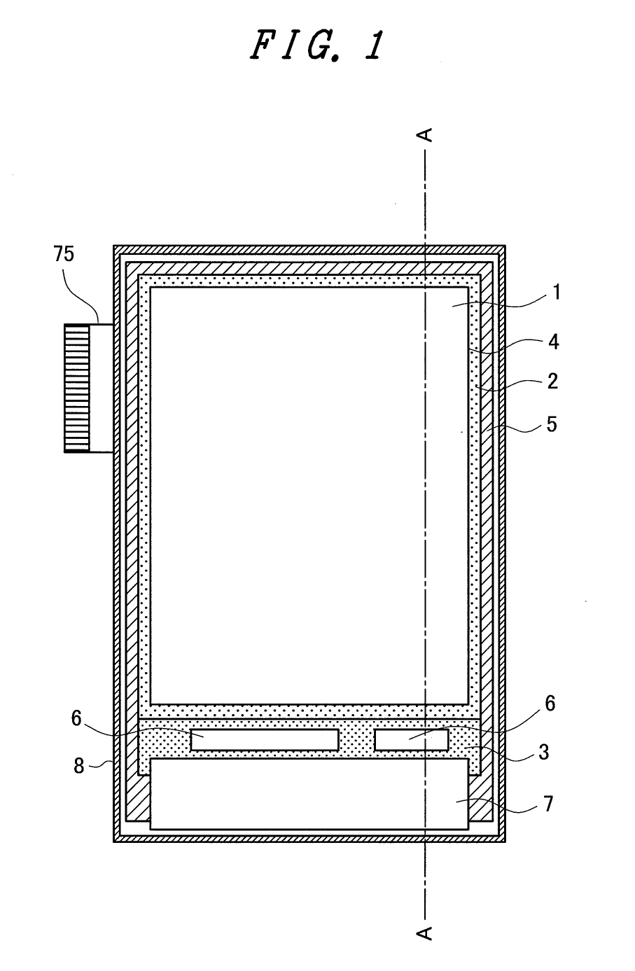

FIG. 1 is a plan view of a display device according to the invention. Parts identical with the parts explained in the related art are given same numerals. Out of a liquid crystal panel 1, an upper polarizer 4, an upper glass substrate 2 and a lower glass substrate 3 are shown in the drawing. IC chips 6 for driving the liquid crystal panel 1 are mounted on the lower glass substrate 3. The liquid crystal panel 1 is mounted on a holder 5. A flexible printed circuit board 7 is connected to the lower glass substrate 3, is folded back at an end portion of the holder 5, and extends to a back surface of the holder 5. The liquid crystal panel 1, the holder 5, the flexible printed circuit board 7 and the like are housed in a frame 8 made of metal. An outer terminal 75 of the flexible printed circuit board 7 which constitutes an interface with a set side is observed from a back side of the display device.

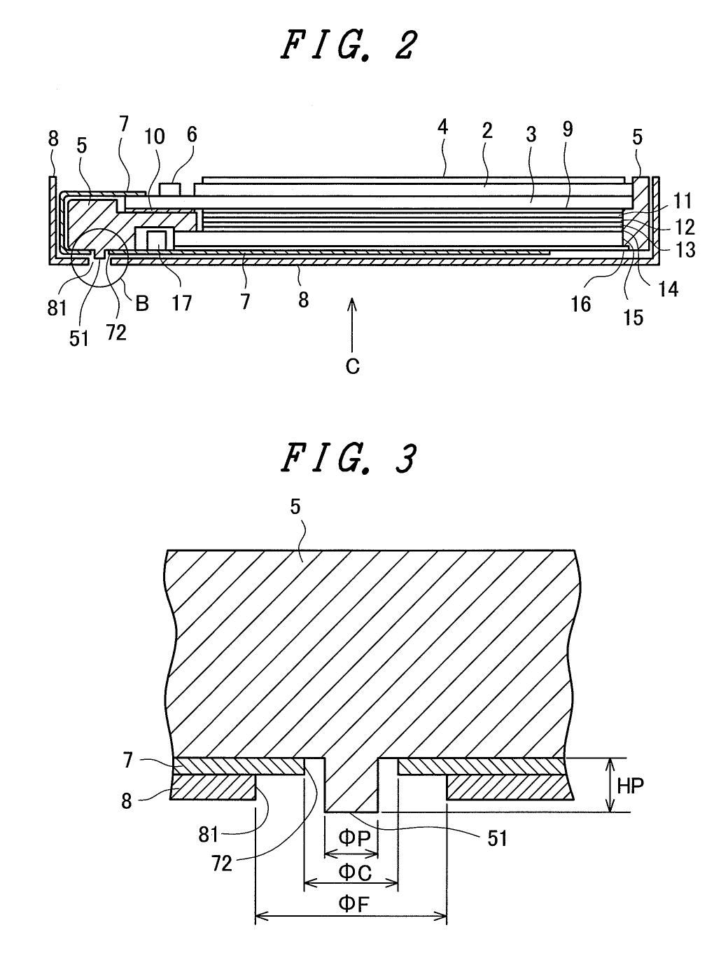

FIG. 2 is a cross-sectional view taken along a line A-A in FIG. 1. Liquid crystal is sandwiched between the upper glass substrate 2 and the lower glass substrate 3 and an image signal is supplied to respective pixels to form an image. The upper polarizer 4 is adhered to an upper surface of the upper glass substrate 2, and a lower polarizer 9 is adhered to a lower surface of the lower glass substrate 3. The liquid crystal panel 1 is constituted of the upper glass substrate 2 and the lower glass substrate 3 which sandwich the liquid crystal therebetween, the upper polarizer 4 and the lower polarizer 9. On a lower-glass-substrate-3 side, a thin film transistor (TFT), a scanning line and a signal line are formed for driving the liquid crystal for every pixel. The driver IC chips 6 for driving the liquid crystal are mounted on the lower glass substrate 3, and these driver IC chips 6 supply image data through the signal lines and the scanning lines. The lower glass substrate 3 is adhered to the holder 5 using a pressure sensitive adhesive double coated tape 10 which possesses light blocking property. The pressure sensitive adhesive double coated tape 10 possesses light blocking property and hence, it is possible to prevent lowering of a contrast of an image attributed to leaking of light from the backlight to the vicinity of the liquid crystal panel 1.

Control signals, a power source and the like to the driver IC chips 6 are supplied from a circuit which is mounted on the flexible printed circuit board 7. The flexible printed circuit board 7 is folded back at an end portion of the holder 5, extends to a back surface of the holder 5, and further extends along the back surface of the backlight. A light emitting diode (LED 17) is mounted on the flexible printed circuit board 7 and constitutes a light source of the backlight. The LED 17 faces a side surface of a light guide plate 15 in an opposed manner.

The light guide plate 15 plays a role of directing the light from the LED 17 incident from the side surface of the light guide plate 15 to a main surface of the liquid crystal. A lower diffusion sheet 14, a lower prism sheet 13, an upper prism sheet 12 and an upper diffusion sheet 11 are mounted on the light guide plate 15. The upper diffusion sheet 11 is adhered to the lower polarizer 9 of the liquid crystal. The lower diffusion sheet 14 plays a role of making the light uniform by eliminating irregularities of the light which advances to the liquid crystal panel 1 from the light guide plate 15. Grooves having a triangular cross section are formed in the prism sheet at a pitch of approximately 50 μm, and the prism sheet plays a role of collecting light from the lower diffusion sheet 14 in the direction toward a main surface of the liquid crystal panel 1. On the lower prism sheet 13 and the upper prism sheet 12, the grooves having a triangular cross section are respectively formed in a state that the grooves formed on the lower prism sheet 13 and the grooves formed on the upper prism sheet 12 are arranged perpendicular to each other thus collecting the light in the screen horizontal direction and in the screen vertical direction in the direction toward the liquid crystal panel 1. The upper diffusion sheet 11 plays a role of supplying the uniform light to the liquid crystal panel 1 by suppressing irregularities of light from the prism sheets. A reflection sheet 16 is arranged below the light guide plate 15. The reflection sheet 16 reflects light which advances downwardly from the light guide plate 15 thus directing the light to the liquid-crystal-panel-1 side and hence, the utilization efficiency of the light is increased. The backlight is constituted of the LED 17, the reflection sheet 16, the light guide plate 15, the lower diffusion sheet 14, the lower prism sheet 13, the upper prism sheet 12 and the upper diffusion sheet 11 which are explained above.

The technical feature of this embodiment lies in a portion B shown in FIG. 2. Holder pins 51 are formed on a lower portion of the holder 5. Although the holder pins 51 are pins which are also used in the related art for the alignment of the holder 5 and the flexible printed circuit board 7, the holder pins 51 of this embodiment differ from the holder pins of the related art in the manner of operation and advantageous effects. That is, different from the related art, the holder pins 51 are inserted into punch-out holes 72 formed in the flexible printed circuit board 7 at the plating terminals 71. Here, frame pin holes 81 are formed in the frame 8 at portions corresponding to the holder pins 51.

FIG. 3 is an enlarged view of the portion B shown in FIG. 2. In FIG. 3, a height HP of the holder pin 51 is set to 0.5 mm, a diameter φP of the holder pin 51 is set to 0.7 mm, a diameter φC of the punch-out hole 72 formed in the flexible printed circuit board 7 at the plating terminal 71 is set to 1.1 mm, and a diameter φF of the frame pin hole 81 is set to 1.9 mm. Here, even when the punch-out hole 72 at the plating terminal 71 is displaced from the holder pin 51 due to part clearance, the operation accuracy or the like thus bringing a copper line exposed portion of the punch-out hole 72 formed in the flexible printed circuit board 7 into contact with the holder pin 51, there arises no problem. This is because that the holder pin 51 is made of a resin. That is, the holder pin 51 is an insulator.

What is important here is that the frame 8 made of metal is not brought into contact with the punch-out hole 72 formed in the flexible printed circuit board 7. To avoid such a contact, it is necessary to set the diameter of the frame pin hole 81 formed in the frame 8 larger than the diameter of the punch-out hole 72 formed in the flexible printed circuit board 7. The size of the punch-out hole 72 formed in the flexible printed circuit board is decided in view of the manufacturing accuracy of parts and the operation accuracy. In this embodiment, the diameter φF of the frame pin hole 81 formed in the frame 8 is set to 1.9 mm, and a distance between an end portion of the frame pin hole 81 and an end portion of the punch-out hole 72 formed in the flexible printed circuit board 7 is set to 0.4 mm on one side. As described above, the size of the diameter of the frame pin hole 81 can be decided in view of the accuracy of parts and the operation accuracy. In the liquid crystal display device having the constitution described in this embodiment, the diameter of the frame pin hole 81 has the tolerance of approximately 0.3 mm to 1.0 mm with respect to the diameter of the punch-out hole 72 formed in the flexible printed circuit board 7 on one side. That is, the diameter of the frame pin hole 81 may be set larger than the diameter of the punch-out hole 72 by approximately 0.6 mm to 2.0 mm in diameter.

Advantages of this embodiment are as follows. That is, the holder pin formed on the holder 5 is inserted into the punch-out hole 72 formed in the flexible printed circuit board 7 and hence, even when the punch-out hole 72 formed in the flexible printed circuit board 7 is displaced due to some reasons, the holder pin functions as a stopper whereby there is no possibility that the position of the punch-out hole 72 is displaced by a fixed value or more. Accordingly, there is no possibility that the punch-out hole 72 formed in the flexible printed circuit board 7 is brought into contact with the frame 8 by getting over the frame pin hole 81. Due to such a constitution, it is possible to surely avoid short-circuiting attributed to a phenomenon that the frame 8 is brought into contact with the copper line of the punch-out hole 72 formed in the flexible printed circuit board.

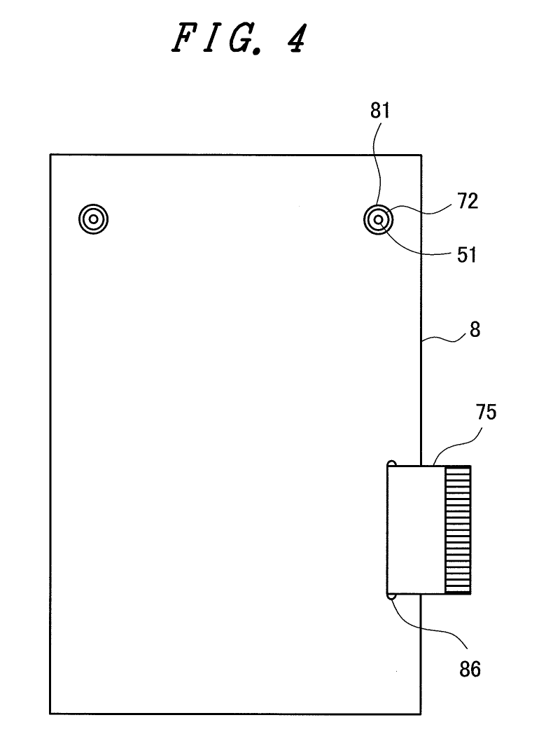

FIG. 4 is a view of the liquid crystal display device as viewed from the direction C shown in FIG. 2. That is, FIG. 4 is a view of the display device of this embodiment as viewed from a back side. The frame pin hole 81 corresponding to the punch-out hole 72 formed in the flexible printed circuit board 7 is formed at two upper positions of the frame 8. The punch-out hole 72 formed in the flexible printed circuit board 7 is provided in the inside of the frame pin hole 81. Here, the holder pin 51 is inserted into the punch-out hole 72. Respective sizes of the holder pin 51 and the frame pin hole 81 are as explained above in conjunction with FIG. 3. In this embodiment, the relationship between the sizes of the holder pin 51 and the frame pin hole 81 is set such that the holder pin 51 and the frame pin hole 81 function as guides in assembling the frame 8 and the holder 5.

As shown in FIG. 4, in this embodiment, all of the holder pin 51, the punch-out hole 72 formed in the flexible printed circuit board 7 and the frame pin hole 81 formed in the frame 8 are provided in two. This is because that the provision of two for each part is convenient in using the holder pin 51 and the frame pin hole 81 as assembling guides. On a lower side of FIG. 4, a cutout 86 for taking out an outer terminal 75 of the flexible printed circuit board 7 is formed. The outer terminal 75 is taken out from the cutout 86 for receiving a required input from the set side.

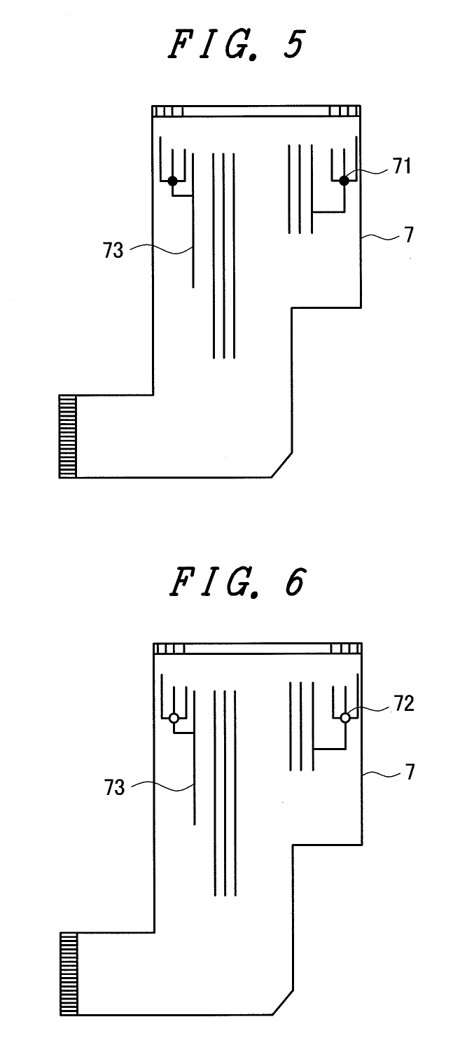

FIG. 5 is a planar schematic view of the flexible printed circuit board 7 used in this embodiment. The plating terminal 71 is provided at two positions on right and left sides. Four common lines for plating extend from the respective plating terminals 71. Accordingly, in this embodiment, it is possible to supply an electric current for plating to all lines 73 of the flexible printed circuit board 7 from eight lines thus increasing the tolerance in designing of lines.

After performing the plating of the lines 73, to protect the lines 73, an adhesive material is applied to the lines 73 by coating and the lines 73 are covered with a cover film. Thereafter, as shown in FIG. 6, the punch-out holes 72 are formed by punching out portions of the flexible printed circuit board 7 at the plating terminals 71 thus ensuring the necessary insulation between the lines 73 of the flexible printed circuit board 7. In this embodiment, the punch-out hole 72 formed in the flexible printed circuit board 7 is provided in two. However, the punch-out holes 72 can be simultaneously formed at the time of punching out a profile of the flexible printed circuit board 7. Accordingly, even when the plurality of holes is formed in the flexible printed circuit board 7, the number of steps is not increased.

The holder pins 51, the positioning holes 74 formed in the flexible printed circuit board 7, the positioning holes 82 formed in the frame 8 and the like which are used as guides in assembling the holder 5, the flexible printed circuit board 7, the frame 8 and the like are also used in the related art. A particular advantageous effect of this embodiment lies in that by providing the plating terminal 71 or the punch-out hole 72 of the flexible printed circuit board 7 in the vicinity of the holder pin 51, without changing the conventional assembling process, it is possible to eliminate the possibility that the plating terminal 71 of the flexible printed circuit board 7 and the metal frame 8 are brought into contact with each other.

In this embodiment, the plating terminal 71 of the flexible printed circuit board 7 is provided at two positions. It is needless to say, however, that the plating terminal 71 may be provided only at one position depending on designing of lines. Further, in this embodiment, the explanation has been made with respect to the case in which the punch-out hole 72 formed in the flexible printed circuit board 7, the frame pin hole 81 and the like are formed in a circular shape. However, one of two holes or both holes may be formed in an elongated circular shape or an elliptical shape in view of facilitating assembling processing or enhancing parts accuracy. In view of facilitating the assembling step, one hole may preferably be formed in a circular shape which exhibits small clearance with the holder pin 51, and another hole may preferably be formed in an elongated circular shape or an elliptical shape which exhibits large clearance with the holder pin 51 in one direction. This is because that the part clearance and the assembling accuracy can be absorbed by the elongated circular shape or the elliptical shape. Further, even when both holes are formed in a circular shape, it is unnecessary to make both holes have the same diameter, and one hole may exhibit small clearance with the holder pin 51 and another hole may exhibit large clearance with the holder pin 51.

### Embodiment 2

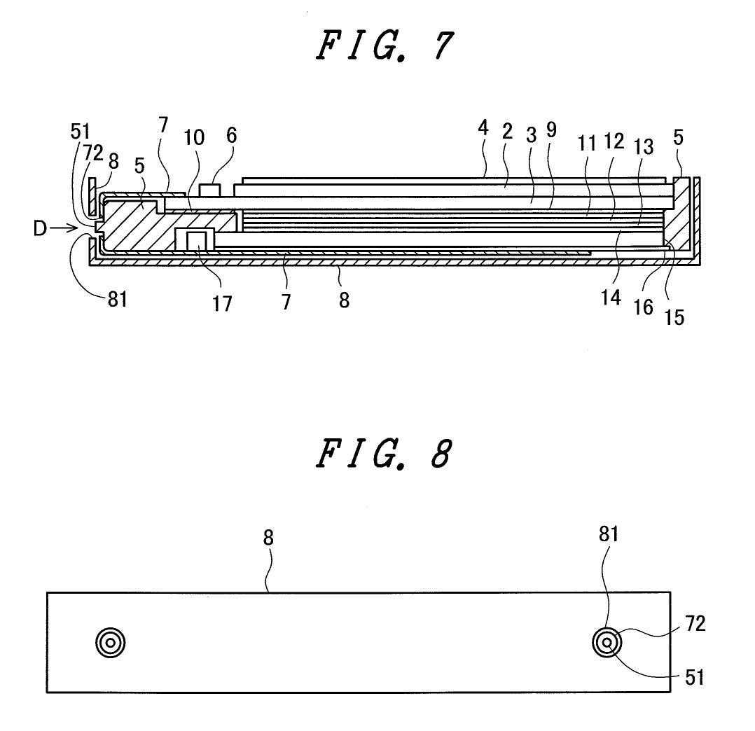

In the embodiment 1, the holder pins 51, the punch-out holes 72 formed in the flexible printed circuit board 7, the frame pin holes 81 formed in the metal frame 8 and the like are arranged on a lower portion of the holder 5. However, it is not always necessary to form these elements on the lower portion of the display device. In an embodiment 2, the holder pins 51 are mounted on side portions of the holder 5, and plating terminals 71 and punch-out holes 72 of the corresponding flexible printed circuit board 7 and frame pin holes 81 formed in the frame 8 are arranged on a side portion of the display device. FIG. 7 is a cross-sectional view of the liquid crystal display device of the embodiment 2. Further, FIG. 8 is a view of the liquid crystal display device as viewed from the direction D shown in FIG. 7. A wiring pattern, a manufacturing method and the like of the flexible printed circuit board 7 in this embodiment are equal to the wiring pattern, the manufacturing method and the like of the flexible printed circuit board 7 in the embodiment 1.

Also in this embodiment, in the same manner as the embodiment 1, the holder pins 51, the punch-out holes 72 formed in the flexible printed circuit board 7, the frame pin holes 81 formed in the metal frame 8 can be used as guides for assembling. Further, in the same manner as the embodiment 1, the holder pins 51 function as stoppers and can eliminate the possibility of contacting of the holder pin 51 with the metal frame 8 due to the displacement of the punch-out hole 72 formed in the flexible printed circuit board 7.

### Embodiment 3

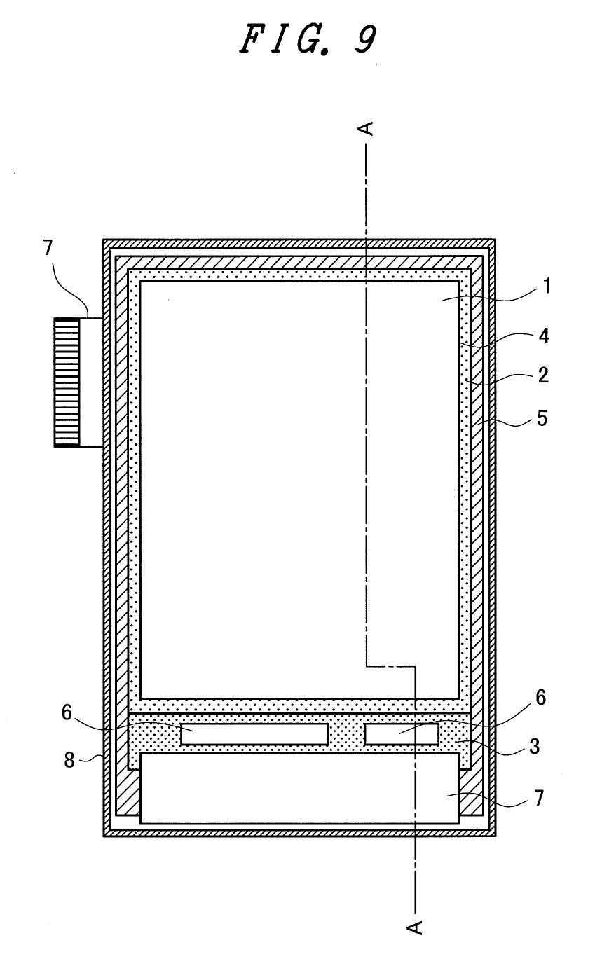

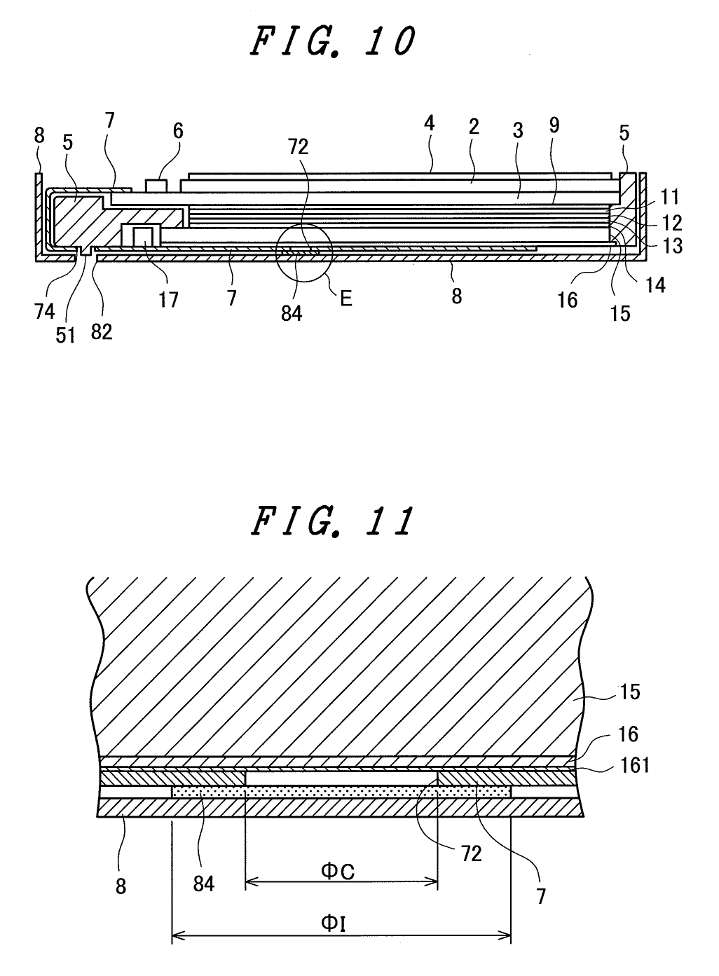

FIG. 9 is a plan view of a display device to which this embodiment is applied. In this plan view, a surface of the display device is equal to the surface of the display device shown in FIG. 1. FIG. 10 is a cross-sectional view taken along a line A-A in FIG. 9. The explanation is made by assuming that plating terminals 71 and punch-out holes 72 for plating terminals formed in a flexible printed circuit board 7 of this embodiment are arranged at the same positions as corresponding holes formed in FIG. 19 and FIG. 20. In this embodiment, the punch-out hole 72 at the plating terminal 71 of the flexible printed circuit board 7 is arranged at a position sandwiched by a reflection sheet 16 and a frame 8. Holder pins 51 shown in FIG. 10, in the same manner as the related art, correspond to positioning holes 74 formed in the flexible printed circuit board 7 and, at the same time, correspond to positioning holes 82 formed in the frame 8. Further, the holder pins 51 have a role of guides for assembling the holder pins 51 and the holder 5 or guides for assembling the frame 8 and the holder 5.

The technical feature of this embodiment lies in a portion E in FIG. 10. The punch-out hole 72 formed in the flexible printed circuit board 7 is sandwiched by metals and hence, when such a constitution unchanged, there exists possibility of short-circuiting of lines of the flexible printed circuit board 7 attributed to the punch-out hole 72. FIG. 11 shows a detail of a portion D in FIG. 10. Since a reflection sheet 16 requires high reflectance, the reflection sheet 16 is formed of an Al sheet, for example. Since the reflection sheet 16 which exhibits high reflectance is necessary only on a light-guide-plate-15 side, anodized aluminum treatment is applied to a back side of the reflection sheet 16 opposite to the light-guide-plate-15 side thus forming an Al₂O₃ film which functions as an insulation film 161. Due to such a constitution, it is possible to prevent possibility of short-circuiting on the reflection-sheet-16 side. Further, to portions of the frame 8 which correspond to the punch-out holes 72 formed in the flexible printed circuit board 7, an insulation paint 84 is applied by coating. The coated film has a small thickness and hence, a thickness of the whole display device is not influenced by the coated film. Further, the coated film is formed to the inside of the display device and hence, appearance of the display device is not influenced by the coated film. Although a diameter φI of the insulation coated film may be set larger than a diameter φC of the punch-out hole 72 formed in the flexible printed circuit board 7, a size of a diameter φI of the insulation coated film may be formed sufficiently larger than a diameter φC of the punch-out hole 72. Further, it is not always necessary to form a shape of the coated film in a circular shape, and the coated film may be formed in any free shape provided that the insulation coated film is sufficiently large to cover the punch-out hole 72 formed in the flexible printed circuit board 7.

In this embodiment, the positions of the plating terminals 71 of the flexible printed circuit board 7 and the punch-out holes 72 formed in the flexible printed circuit board 7 are not limited to positions of the plating terminals 71 of the flexible printed circuit board 7 or the punch-out holes 72 formed in the flexible printed circuit board 7 shown in FIG. 19 and FIG. 20, and the positions of the plating terminals 71 and the punch-out holes 72 may be selected in a wide range.

In this manner, according to this embodiment, with the use of the simple process which exhibits large operation tolerance, it is possible to prevent the influence of the punch-out hole 72 formed in the flexible printed circuit board 7 on line short-circuiting. In this embodiment, since the vicinity of the punch-out hole 72 formed in the flexible printed circuit board 7 is covered with the frame 8, it is also possible to eliminate the influence attributed to the adhesion of a conductive material to the punch-out hole 72 formed in the flexible printed circuit board 7 from the outside.

### Embodiment 4

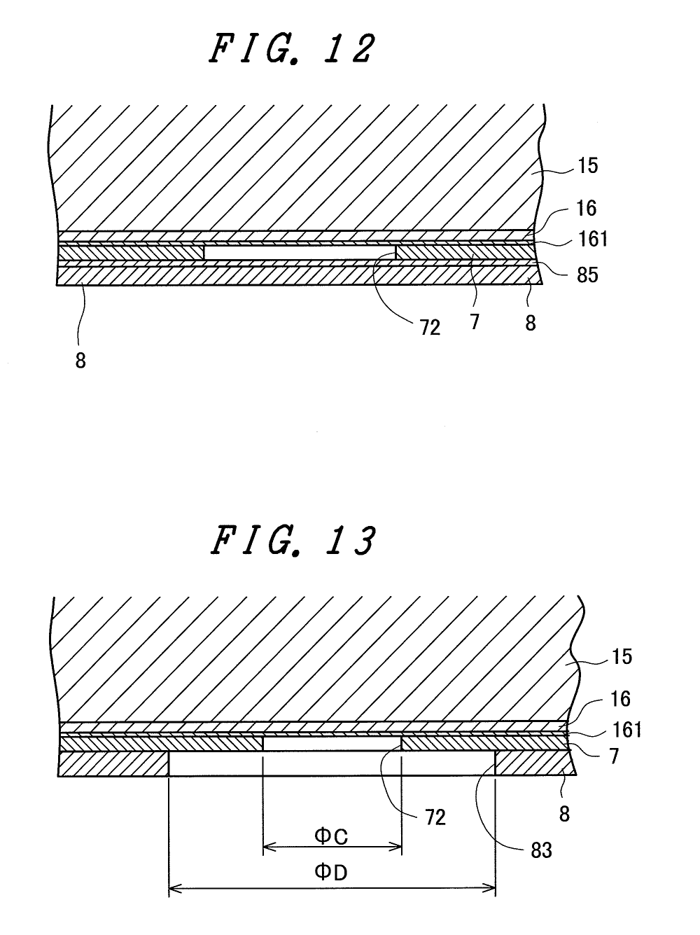

A plan view of a display device to which this embodiment is applied is equal to FIG. 9. The explanation is made by assuming that plating terminals 71 and punch-out holes 72 for plating terminals of a flexible printed circuit board 7 of this embodiment are arranged at the same positions as corresponding terminals and holes formed in FIG. 19 and FIG. 20. FIG. 12 is a cross-sectional view showing the vicinity of the punch-out hole 72 for plating terminal formed in the flexible printed circuit board 7 of this embodiment. This embodiment differs from the embodiment 3 with respect to a point that in place of forming the insulation paint 84 in FIG. 10, an insulation film 85 is formed on an inner surface of a metal frame 8.

That is, by forming the insulation film 85 on the inner surface of the metal frame 8, it is possible to prevent short-circuiting of lines of the flexible printed circuit board 7 in the punch-out hole 72 formed in the flexible printed circuit board 7. For example, when the metal frame 8 is made of aluminum or aluminum alloy, it is possible to easily form an insulation film 85 by anodized aluminum treatment. It is needless to say that a material of the frame 8 is not limited to aluminum or aluminum alloy, and this embodiment is applicable to any material provided that the material is metal to which the insulation-film-85 treatment can be applied. The insulation film 85 is formed on only the inner side of the frame 8 in FIG. 12, however, the insulation film 85 may be formed on the whole frame 8. In this case, the stable insulation film 85 can cover the whole frame 8 and hence, corrosion of the frame 8 or the like can be prevented.

Further, in this embodiment, in the same manner as the embodiment 3, an insulation film is formed on a back side of the reflection sheet 16 by anodized aluminum treatment. Further, the manufacture of the flexible printed circuit board 7, the assembly of holders 5, the flexible printed circuit board 7 and the frame 8 and the like are carried out in the same manner as the embodiment 3. According to this embodiment, by merely forming the insulation film on the frame 8, it is possible to prevent possibility of short-circuiting attributed to the influence of the plating terminals 71 and the punch-out holes 72 of the flexible printed circuit board 7. Further, since the punch-out hole 72 formed in the flexible printed circuit board 7 are completely covered with the frame 8, it is also possible to prevent possibility of generating short-circuiting of lines of the flexible printed circuit board 7 attributed to the adhesion of a conductive material on the punch-out holes 72 formed in the flexible printed circuit board 7 from the outside.

### Embodiment 5

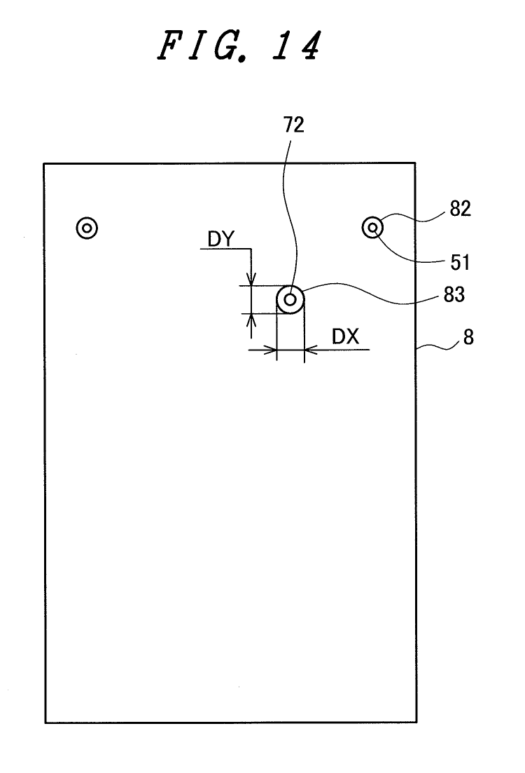

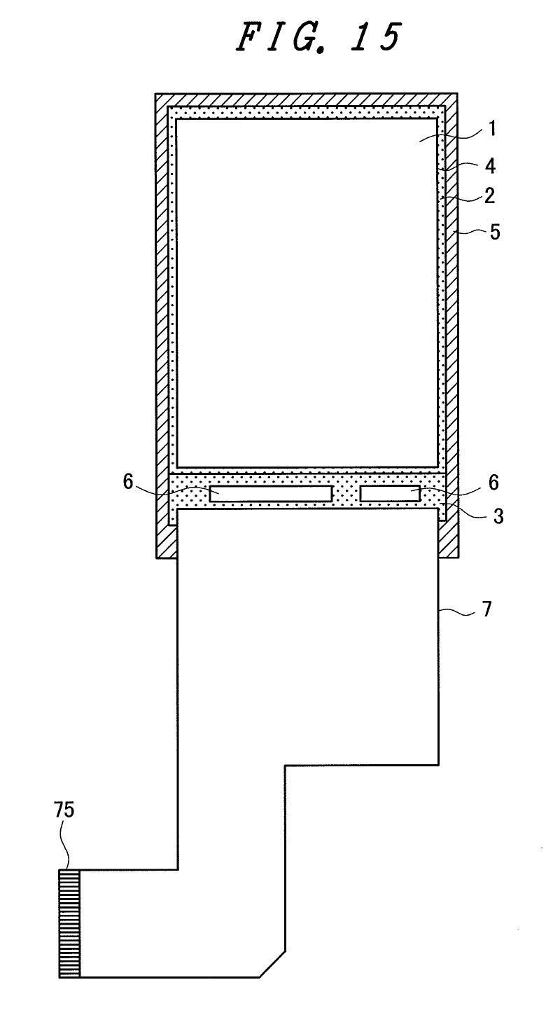

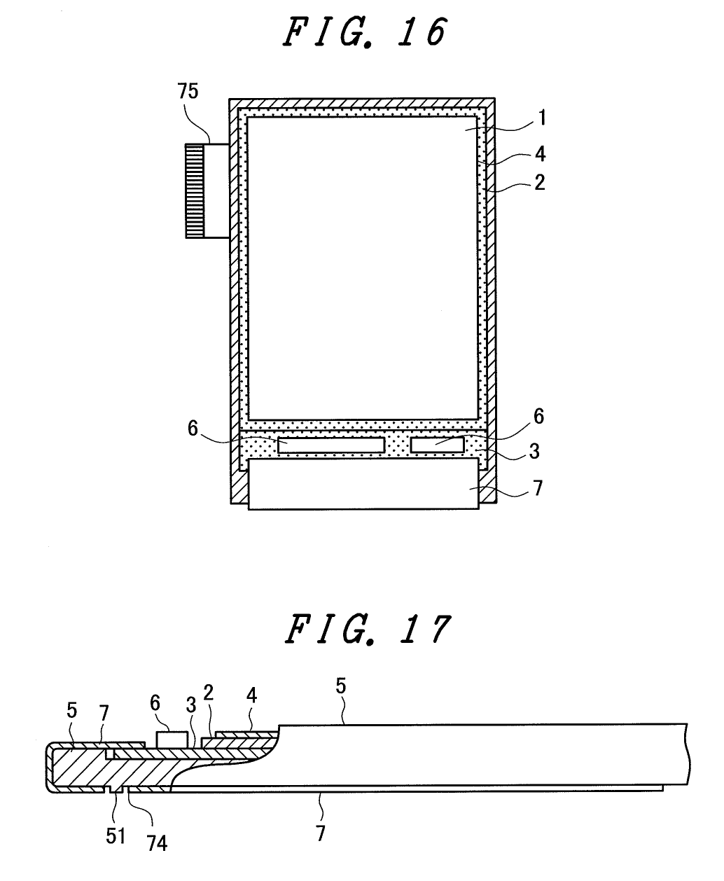

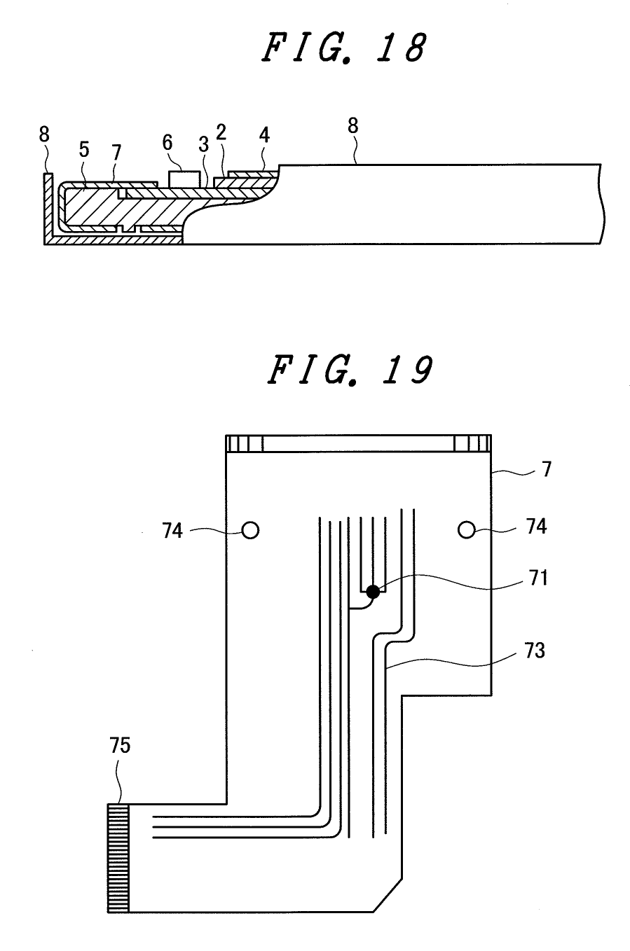

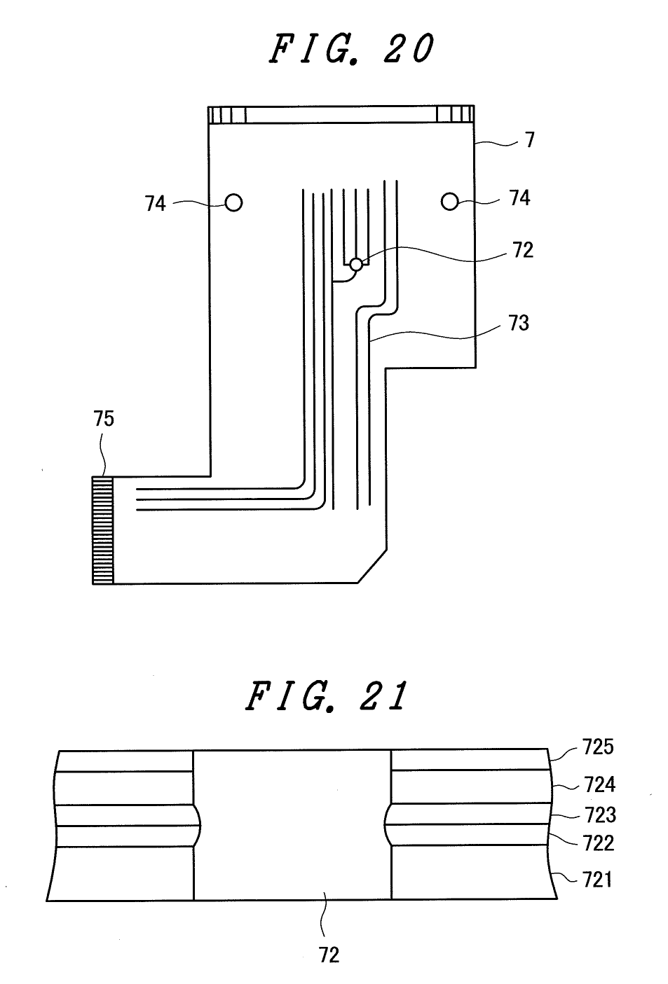

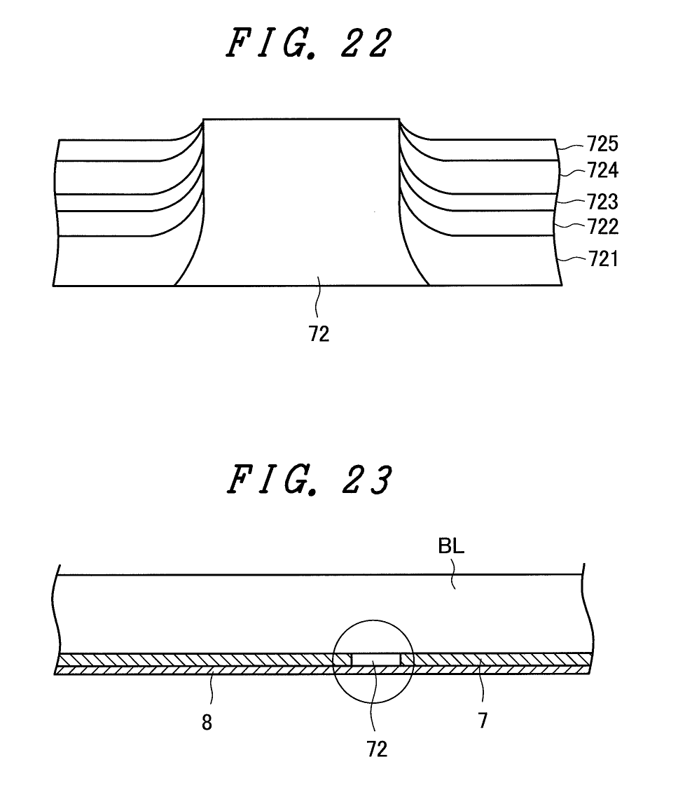

A plan view of a display device to which this embodiment is applied is equal to FIG. 9. The explanation is made by assuming that plating terminals 71 and punch-out holes 72 for plating terminals of a flexible printed circuit board 7 of this embodiment are arranged at the same positions as corresponding terminals and holes formed in FIG. 19 and FIG. 20. FIG. 13 is a cross-sectional view showing the vicinity of the punch-out hole 72 for plating terminal formed in the flexible printed circuit board 7 of this embodiment. This embodiment differs from the embodiment 3 with respect to a point that, without forming the insulation paint 84 shown in FIG. 10, escape holes 83 which are formed of a relatively large hole are formed in the vicinity of the plating terminals 71 and the punch-out holes 72 of the flexible printed circuit board 7. FIG. 14 is a back view of the display device of this embodiment.

In FIG. 13, it is necessary to set a diameter φD of the escape hole 83 formed in the frame 8 larger than a diameter φC of a punch-out hole 72 formed in the flexible printed circuit board 7, and the diameter φD is required to exhibit a relatively large value. This is because that, different from the embodiment 1 and the embodiment 2, in this embodiment, holder pins 51 which plays a role of stoppers for the punch-out holes 72 formed in the flexible printed circuit board 7 are not present. It is necessary to set a diameter φD of the escape hole 83 formed in the frame 8 such that a diameter φD of the escape hole 83 is larger than a diameter φC of the punch-out hole 72 formed in the flexible printed circuit board 7 by 0.5 mm or more on one side and is larger than a diameter φC of the punch-out hole 72 by 1.0 mm in diameter. On the other hand, when the diameter φD of the escape hole 83 formed in the frame 8 is set to an excessively large value, a strength of the frame 8 is adversely influenced and hence, it is preferable to set the diameter φD of the escape hole 83 to a value which exhibits approximately 2.5 mm on one side and 5 mm in diameter with respect to the diameter φC of the punch-out hole 72 formed in the flexible printed circuit board 7. Accordingly, in this case, the diameter of the escape hole 83 formed in the frame 8 assumes a value which falls within a range approximately from 2.1 mm to 6.1 mm.

FIG. 14 is a back view of the display device of this embodiment. It is not always necessary to form the escape hole 83 formed in the frame 8 in circular shape, and the escape hole 83 may have a large diameter on a side which exhibits large irregularities in operation and irregularities in parts. For example, when the flexible printed circuit board 7 is liable to be easily displaced in the lateral direction, DX is set larger than DY in FIG. 14. In FIG. 14, in the same manner as the related art, holder pins 51 and positioning holes 82 formed in the frame 8 are used as guides for assembling a holder 5 and the frame 8.

Also in this embodiment, in the same manner as the embodiment 3 and the embodiment 4, an insulation film is formed on a back surface of a reflection sheet 16. Further, the manufacture of the flexible printed circuit board 7 and the like are also carried out in the same manner as the embodiment 3 and the embodiment 4. According to this embodiment, by properly setting the size of the escape hole 83 formed in the metal frame 8, it is possible to prevent short-circuiting of lines of the flexible printed circuit board 7 attributed to contacting of the metal frame 8 with the plating terminal 71 and the punch-out hole 72 of the flexible printed circuit board 7 thus enhancing the reliability of the liquid crystal display device without particularly pushing up the manufacturing cost.

What is claimed is:

1. A liquid crystal display device comprising:
a liquid crystal panel;
a holder which mounts the liquid crystal panel on an upper surface thereof;
a flexible printed circuit board which is connected with the liquid crystal panel; and
a frame which houses the holder therein, wherein
the flexible printed circuit board is configured such that the flexible printed circuit board extends on a back surface of the holder while surrounding a side surface of the holder,
plating is applied to a line portion of the flexible printed circuit board, the plating is applied to the flexible printed circuit board using a plating terminal for applying plating and, thereafter, a hole for removing the plating terminal is formed in the flexible printed circuit board thus ensuring necessary insulation between lines,
a holder pin is formed on the holder,
a pin hole is formed in the frame,
the holder pin is inserted into the hole for removing the plating terminal formed in the flexible printed circuit board and the pin hole formed in the frame, and
the pin hole formed in the frame is larger than the hole for removing the plating terminal formed in the flexible printed circuit board.

2. A liquid crystal display device according to claim 1, wherein the holder pin is configured to function as a guide for assembling the flexible printed circuit board and the holder and, at the same time, is configured to function as a guide for assembling the holder and the frame.

3. A liquid crystal display device according to claim 1, wherein the hole for removing the plating terminal formed in the flexible printed circuit board is provided at two positions, and the pin hole for the holder pin and the frame are provided at two positions corresponding to the hole for removing the plating terminal formed in the flexible printed circuit board.

4. A liquid crystal display device according to claim 1, wherein the hole for removing the plating terminal formed in the flexible printed circuit board is an elongated circular shape, and a diameter of the pin hole formed in the frame is larger than a long diameter of the elongated circular shape.

5. A liquid crystal display device according to claim 1, wherein the hole for removing the plating terminal formed in the flexible printed circuit board is an elongated circular shape,
the pin hole formed in the frame is an elongated circular shape, and
in comparing the long diameter of the hole for removing the plating terminal and the long diameter of the pin hole as well as the short diameter of the hole for removing the plating terminal and the short diameter of the pin hole, the pin hole exhibits larger values in both of long diameter and short diameter.

6. A liquid crystal display device according to claim 1, wherein the holder pin is formed on a lower portion of the holder.

7. A liquid crystal display device comprising:
a liquid crystal panel;
a backlight which includes a light guide plate arranged on a back surface of the liquid crystal panel;
a reflection sheet arranged on a back surface of the light guide plate;
a holder which mounts the liquid crystal panel, the backlight and the reflection sheet therein;
a flexible printed circuit board which is connected with the liquid crystal panel; and
a frame which houses a holder therein, wherein
the flexible printed circuit board is configured such that the flexible printed circuit board extends on a back surface of the reflection sheet while surrounding a side surface of the holder, plating is applied to a line portion of the flexible printed circuit board, the plating is applied to the flexible printed circuit board using a plating terminal for applying plating and, thereafter, a hole for removing the plating terminal is formed in the flexible printed circuit board to ensure necessary insulation between lines,
the hole for removing the plating terminal formed in the flexible printed circuit board is provided between the reflection sheet and the frame,
insulation treatment is applied to a side of the reflection sheet in which the hole for removing the plating terminal is formed, and
an insulation paint is applied to a portion of the frame corresponding to the hole for removing the plating terminal.

8. A liquid crystal display device comprising:
a liquid crystal panel;
a backlight which includes a light guide plate arranged on a back surface of the liquid crystal panel;
a reflection sheet arranged on a back surface of the light guide plate;
a holder which mounts the liquid crystal panel, the backlight and the reflection sheet therein;
a flexible printed circuit board which is connected with the liquid crystal panel; and
a frame which houses a holder therein, wherein
the flexible printed circuit board is configured such that the flexible printed circuit board extends on a back surface of the reflection sheet while surrounding a side surface of the holder, plating is applied to a line portion of the flexible printed circuit board, the plating is applied to the flexible printed circuit board using a plating terminal for applying plating and, thereafter, a hole for removing the plating terminal is formed in the flexible printed circuit board to ensure necessary insulation between lines,
the hole for removing the plating terminal formed in the flexible printed circuit board is provided between the reflection sheet and the frame,
insulation treatment is applied to a side of the reflection sheet in which the hole for removing the plating terminal is formed, and
an insulation film is formed on an inner side of the frame.

9. A liquid crystal display device according to claim 8, wherein an insulation film is formed on an surface of the frame.

10. A liquid crystal display device comprising:
a liquid crystal panel;
a backlight which includes a light guide plate arranged on a back surface of the liquid crystal panel;
a reflection sheet arranged on a back surface of the light guide plate;
a holder which mounts the liquid crystal panel, the backlight and the reflection sheet therein;
a flexible printed circuit board which is connected with the liquid crystal panel; and
a frame which houses a holder therein, wherein
the flexible printed circuit board is configured such that the flexible printed circuit board extends on a back surface of the reflection sheet while surrounding a side surface of the holder, plating is applied to a line portion of the flexible printed circuit board, the plating is applied to the flexible printed circuit board using a plating terminal for applying plating and, thereafter, a hole for removing the plating terminal is formed in the flexible printed circuit board to ensure necessary insulation between lines,
the hole for removing the plating terminal formed in the flexible printed circuit board is provided at a portion of the flexible printed circuit board which corresponds to a back surface of the reflection sheet,
insulation treatment is applied to a side of the reflection sheet in which the hole for removing the plating terminal is formed,
a hole is formed in a portion of the frame which corresponds to the hole for removing the plating terminal formed in the flexible printed circuit board, and
the hole formed in the frame is larger than the hole for removing the plating terminal formed in the flexible printed circuit board and has a diameter of 6.1 mm or less.
